(19) United States
(12) Patent Application Publication
(10) Pub. No.: US 2008/0127195 A1
(43) Pub. Date: May 29, 2008

(54) Project-process-transformer

(75) Inventor: Klaus Buchner, Kleinsendelbach (DE)

Correspondence Address: BRINKS HOFER GILSON & LIONE, P.O. BOX 10395, CHICAGO, IL, 60610, US

(73) Assignee: Siemens AG

(21) Appl. No.: 11/604,945

(22) Filed: Nov. 28, 2006

(51) Int. Cl. G06F 9/46

(52) U.S. Cl. 718/104

(57) ABSTRACT

A system and method visually depict the status of a process. The process may include a number of phases and projects that are selected to be monitored. Process attribute data may be collected pertaining to the phases and projects, and may be stored in a multi-dimensional database. A process template may be generated that includes a number of segments that correspond to the phases and/or projects. Milestones or other check points associated with a process schedule may be visually depicted in relation to the process template. The process attribute data may be utilized to visually depict the current status of each phase and/or project within the process template. The current status of each phase and/or project may be visually depicted with respect to the milestones. As a result, a composite overall status of the project, with respect to the phases, projects, and milestones, is visually depicted.

### BACKGROUND

The present embodiments relate generally to software applications. In particular, the present embodiments relate to software applications that facilitate monitoring the status of processes.

Business process management software applications are increasing in popularity and a number of process management software tools currently exist. MS Project™ and BizFIOW™ are examples of commercially available business process management applications.

Conventional process management tools may provide process related information to the user via a display screen in a limited number of ways. For instance, typical process management tools may present business process related information from a macroscopic viewpoint. As a result, any information may be presented as only corresponding to the business process as a whole.

### BRIEF SUMMARY

By way of introduction, the embodiments described below include methods, processes, apparatuses, instructions, or systems for monitoring processes at a microscopic level. Each process may include a plurality of phases, and each phase may include a plurality of projects (steps) to be completed. The status of each phase and project may be monitored, such as by collecting process, phase, and project related data. The data collected may be stored in a multi-dimensional data base and used to generate a display that demonstrates the status of each phase and/or project to the user. As a result, an accurate picture of the overall status of the larger process may be ascertained. For instance, the status of each phase and/or project may be visually depicted within a high-level process template. Color schemes may be used to facilitate comprehension of the information displayed. Additionally, the status of each phase and/or project, as well as the overall process, may be monitored with respect to user-defined milestones, such as decision points, review points, or other check points. In one embodiment, the process monitored is a process intended to develop a commercial product by researching the appropriate market and subsequently designing, manufacturing, and testing the product.

In a first aspect, a data processing system visually depicts the status of a process. The system includes a processor operable to generate a high-level graph representing the process, the high-level graph including a plurality of lower-level project portions that each correspond to a project associated with the process. The system also includes a screen operable to display the high-level graph. The processor is operable to monitor the current status of each project and alter a number of the plurality of lower-level project portions displayed within the high-level graph to update the current status of the corresponding projects, and, as a result, a composite overall status of the process may be visually depicted.

In a second aspect, a method visually depicts the status of a process. The method includes displaying a high-level template representing a process on a screen. The high-level template includes a plurality of project portions and each of the plurality of project portions corresponds to a project associated with the process. The method also includes collecting data associated with the process and automatically altering a number of the plurality of project portions displayed within the high-level template to reflect the current status of the corresponding projects based upon the data collected.

In a third aspect, a method visually depicts the status of a process. The method includes selecting a plurality of projects associated with a process to monitor, generating a process template that represents the process and the plurality of projects selected to be monitored, and collecting project data associated with the plurality of projects. The method also includes automatically determining a current status of a number of the plurality of projects from the project data and displaying the current status of the number of the plurality of projects within the process template.

In a fourth aspect, a computer-readable medium has instructions executable on a computer and stored thereon. The instructions include displaying a process diagram representing a process, the process diagram having a plurality of project segments that each represent a corresponding project associated with the process. The instructions also include collecting project data related to each project, calculating a current project status of at least one project based upon the project data collected, and visually depicting the current project status of the at least one project within the process diagram.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The present embodiments will become more fully understood from the detailed description given herein below and the accompanying drawings which are given by way of illustration only, and are not limitative of the present invention, and wherein:

FIG. 1 is an exemplary method of visually depicting the status of a process;

FIG. 2 illustrates exemplary processes, phases, and projects to be monitored;

FIG. 3 is an exemplary project overlay superimposed upon a process template; and

FIG. 4 is an exemplary data processing system operable to visually depict the overall status of the process.

### DETAILED DESCRIPTION OF THE DRAWINGS AND PRESENTLY PREFERRED EMBODIMENTS

The embodiments described herein include methods, processes, apparatuses, instructions, or systems for presenting the overall status of a process by monitoring the status of process phases and/or process projects (steps) associated with the completion of the process. Each phase may involve a number of projects. To facilitate ascertaining the current status of the process, a number of “process attributes” may be selected to be monitored. Each of the process attributes selected may correspond to the process generally, or a particular phase and/or project associated with the process.

A software application may be used during the identification of the process attributes (“process attributes” as used herein includes process, phase, and/or project specific attributes) to be monitored. Subsequently, the process attribute data related to phases and/or projects selected to be monitored may be collected. In one embodiment, MS Project™ is used to facilitate identification of process attributes. Other software tools may be used to select process attributes to monitor.

The process attribute data may be collected automatically using software and/or processing units solely or in conjunction with manual data entry. The process attribute data collected may then be segregated by process (if multiple processes are being monitored), corresponding phase and/or project, and time. For instance, the process attribute data may be collected in so-called bundles of data. Each data bundle may be received at a central processor from a distinct source, such as a remote terminal. Each data bundle may be associated with a particular phase and/or process, and be flagged as such. Additionally, each data bundle may be time stamped or otherwise associated with a specific time or timeframe, such as a timeframe over which the data within the bundle pertains to or was collected.

The process attribute data may be stored in a multi-dimensional data structure. The data structure may have one dimension defined by process and another dimension defined by time. For example, the data structure may be a two-dimensional table or grid having process and time dimensions. Phase and project data may be sorted and stored within the process dimension. Other multi-dimensional data structures may be used.

The software application may generate a high-level process diagram or template representing the overall process. The high-level process template may have a number of portions designated to represent each phase and/or project that must be completed to finish the process. The attribute information collected and stored may then be exported into the high-level process template to visually depict the current status of each of phase and/or project within the high-level process diagram. As a result of the phase and/or project status being displayed within the high-level process template, a composite overall status of the process may be visually depicted.

The current status of each phase or project may correspond to an actual or an estimated percentage of the phase or project that is currently completed. Additionally, each phase and/or project may have a corresponding icon that visually represents it within the high-level process template. The size of a phase and/or project icon may be altered to correspond with the percent of the corresponding phase or project actually or estimated (such as by a processor) to be currently completed. The current status of phases and/or projects may be represented in alternative manners.

A color scheme may be employed to depict the current status of each phase and/or project. For instance, if a project is depicted in green, it may visually represent that the project is ahead of schedule. If a project is depicted in yellow, it may visually represent that the project is approximately on schedule. And if a project is depicted in red, it may visually represent that the project is behind schedule. Other color schemes may be used.

A number of milestones or other check points may be associated with the process or the underlying phases and/or projects. An icon may be generated to represent each milestone. The icons may be displayed on a display positioned in relation to the high-level process template. After the current status of one or more the phases and/or projects is updated graphically or otherwise on the display, the status of the process with respect to the milestones is visually depicted. As a result, whether the overall process or the individual phases and/or projects are in danger of missing or have missed various milestones may be easily ascertained by viewing the display. At which point, a determination may be made to reallocate resources or allocate more resources to an appropriate problem area, such as a specific project behind schedule, to get the overall process or the specific project back on schedule. A processor may analyze all of the available resources and the status of each phase and/or project to estimate a reallocation of resources, or an allocation of additional resources, to get the schedule back on track. For instance, resources, such as engineering or manufacturing personnel, from a project ahead of schedule may be temporarily reallocated or reassigned to a phase or project behind schedule. Other reallocations of resources may be made.

In one embodiment, the process monitored may be a business process. The business process may involve the development of a medical device, which may include numerous tasks required to be accomplished to comply with FDA regulations. As such, the process may include one or more phases and/or projects related to the design, manufacture, and testing of the medical device being developed. The medical device being developed by the process depicted on the display may include x-ray, MRI (magnetic resonance imaging), CT (computed tomography), ultrasound, PET (positron emission tomography), or other medical devices.

### I. Exemplary Method

In general, the method disclosed herein may provide for monitoring a plurality of process projects. The method may use a project management tool to add process attributes to planned work steps (projects) and/or process phases. All of the process/phase/project data including the process attributes may be stored in a multi-dimensional time grid or table within a database. If multiple processes are being monitored, the method may involve correlating, such as via a data processor, phase and/or project data collected to a specific process and/or time.

The phase and/or project data, which may detail the degree of completion of the phase or project, respectively, may be associated with corresponding phase and/or project segments of a process diagram. The method may automatically display process information with related phase and/or project information superimposed. Process data and project data may be correlated from the initiation of the process, such that a comprehensive presentation of the relationship between the process and the underlying projects may generated, as well as a comprehensive interconnection of the process data and the corresponding project data being maintained, as well as continuously updated, within a database.

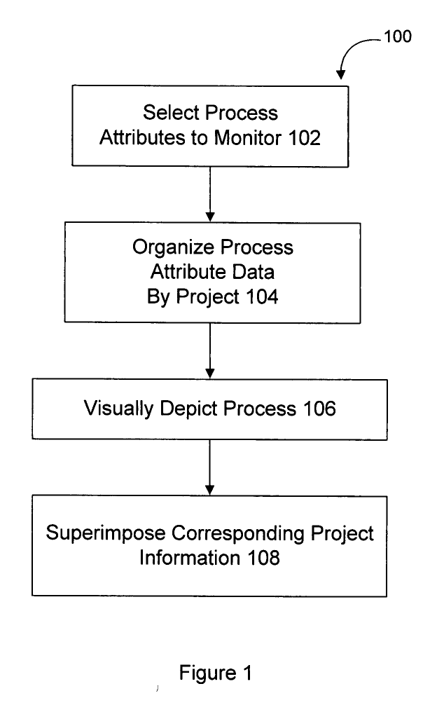

FIG. 1 demonstrates an exemplary method of graphically depicting the status of a process 100. The method may include selecting process attributes to monitor 102, organizing the process attribute information by project 104, visually depicting the process 106, and superimposing corresponding project specific information onto the visual depiction of the process 108. The method may include additional, fewer, or alternate actions.

The method may include selecting process attributes to monitor 102. The process attributes identified to be monitored may relate to a process in general. The process may include a number of phases and/or projects which must be completed to finish the process. Accordingly, the process attributes also may be associated with a specific phase and/or project identified to be monitored. A project management tool may be used to facilitate collecting the process attribute information.

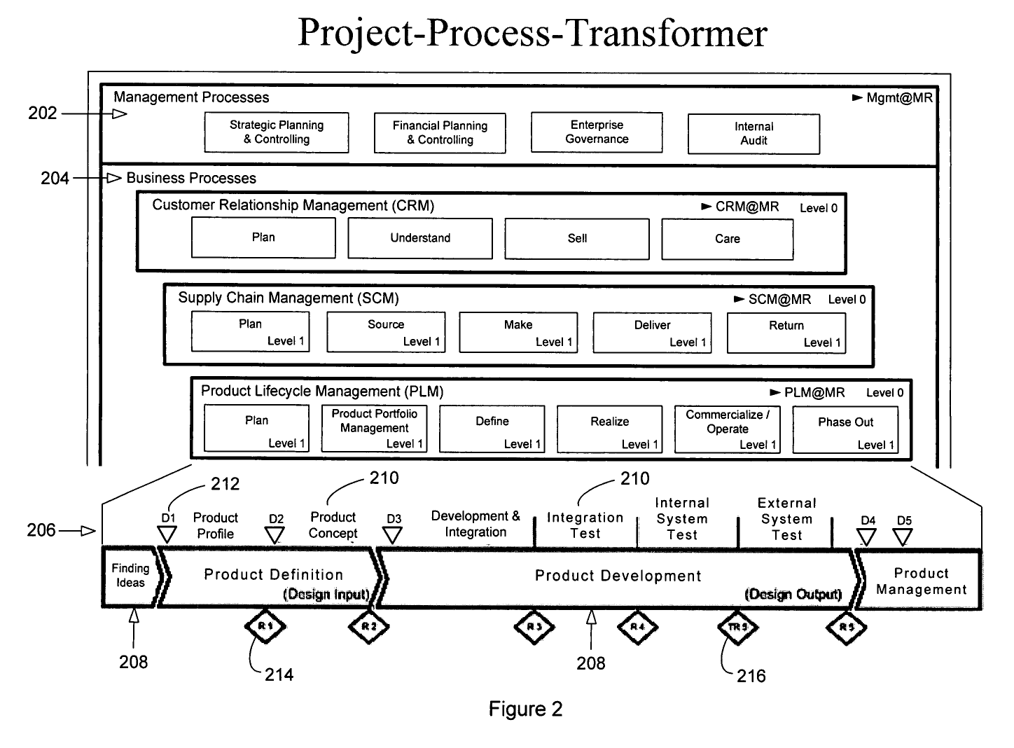

FIG. 2 illustrates exemplary management processes 202 to be monitored. As displayed, exemplary management processes 202 to be monitored may be directed toward strategic planning and control, financial planning and control, enterprise governance, and internal audit. Other management processes may be monitored.

The method may include organizing the attribute information by project 104. A data processor and/or software algorithm may be used classify the process attribute information gathered by specific process, phase, and/or project. Characterizing the attribute information by specific phase and/or project, instead of only by the overall process, may facilitate the presentation of a more accurate and complete picture, as compared to conventional applications, of the overall status of the entire process, including the status of each phase and/or project.

FIG. 2 also demonstrates that a number of exemplary business processes 204 may be monitored. The business processes 204 shown include customer relationship management (CRM), supply chain management (SCM), and product lifecycle management (PLM). Other business processes may be monitored.

The customer relationship management process shown includes exemplary projects related to (1) planning, (2) understanding, (3) selling, and (4) caring. The supply chain management process shown includes exemplary projects related to (1) planning, (2) sourcing, (3) making, (4) delivering, and (5) returning products. The product lifecycle management process includes exemplary projects related to (1) planning, (2) product portfolio management, (3) definition, (4) realization, (5) commercialization/operations, and (6) phasing out products. Other projects may be selected and monitored, including those discussed herein.

In the case that multiple processes are being monitored, the system may gather process attribute data related to projects associated with a number of processes, such as shown in FIG. 2. The system may automatically determine which process a newly received bundle of project data pertains to and store that project data bundle accordingly. For instance, the project data bundle may be stored in a data structure associated only with the corresponding process, such as a table, grid, queue, tree, stack, list, or other data structure. Alternatively, the project data bundle may be associated with a flag or other identifier that denotes the corresponding process to which the project data bundle belongs.

The method may include visually depicting the process 106. A high-level graph or template representing the process may be generated. The high-level process template may have a plurality of segments corresponding to phases associated with the process. The high-level process may have a plurality of portions corresponding to projects associated with the process. A segment representing a phase may include one or more portions corresponding to projects that must be finished to complete the phase. In one embodiment, the high-level template may be a bar chart, pie chart, or other graphic. The graphical depiction of the process may occupy an entire window or only a portion thereof. Other high-level process templates may be used.

The exemplary process template 206 of FIG. 2 illustrates that a number of phases 208 within a process may be selected to be monitored and subsequently visually represented within the process template 206. The exemplary phases 208 relate to finding ideas, product definition, product development, and product management.

The finding ideas phase may include collecting ideas from various sources, such as customers and sales personnel. The project definition (design input) phase may include the engineering development of the product being developed. The product development (design output) phase may include the manufacturing aspect of the product being developed after the product design has been finalized in part or in whole. The product management phase may include monitoring reaction to and acceptance of the product in the marketplace and continuous improvement of the product. Additional, fewer, or alternate phases may be used.

The exemplary process template 206 of FIG. 2 also illustrates a number of projects 210 within the process may be selected to be monitored and subsequently visually represented by the process template 206. The exemplary projects 210 relate to product profile, product concept, development and integration, integration test, internal system test, and external system test. The product profile and product concept projects 210 are part of the product definition phase 208. The development and integration, integration test, internal system test, and external system test projects 210 are part of the product development phase 208.

The product profile project may include marketing research to determine what the marketplace wants. The product concept project may include developing a product to meet demand and identifying the best concepts to market with respect to technology and costs. The development and integration project may include developing and integrating system components. The integration test project may include integrating the components into the overall system being developed. The internal system test project may include troubleshooting individual system components or the entire system. The external system test project may include troubleshooting the system as it is being tested with the customer's equipment at the customer's site. Additional, fewer, or alternate projects may be used.

The graphical depiction of the process may include a number of icons representing decision points associated with the process or a specific project. Each decision point may be a point in the development process where documents, such as technical designs or testing results, are reviewed and must be finalized before a next portion of the process may be either commenced or completed. For instance, some projects may be required to be completed in a linear fashion. FIG. 2 illustrates exemplary decision points 212. Other decision points may be used.

The graphical depiction of the process may include a number of icons representing review points 214 associated with the process or a specific project. Each review point 214 may be a designated point in the process or a project at which management needs to review the status of the process or project. For instance, a particular point in the process or project may be required to be reached before further financing is obtained. Alternatively, designs may have to be reviewed and approved at particular points. FIG. 2 illustrates exemplary review points 214. Other review points may be used.

The graphical depiction of the process may include a number of icons 216 representing milestones associated with the completion of the process or a specific phase and/or project. Each milestone may be predetermined according to a particular development process. FIG. 2 illustrates an exemplary milestone icon 216. Other milestones may be used. For instance, the decision and review points described above also may be so-called milestones as defined herein.

The method may include superimposing or overlaying project specific information onto the graphical depiction of the process 108 (FIG. 1). The process attributes selected to be monitored corresponding to a specific phase/project may be used to generate corresponding overlay information. As a result, an overlay detailing the phase and project information collected may be superimposed upon the high-level process template to graphically depict a composite overall status of the process.

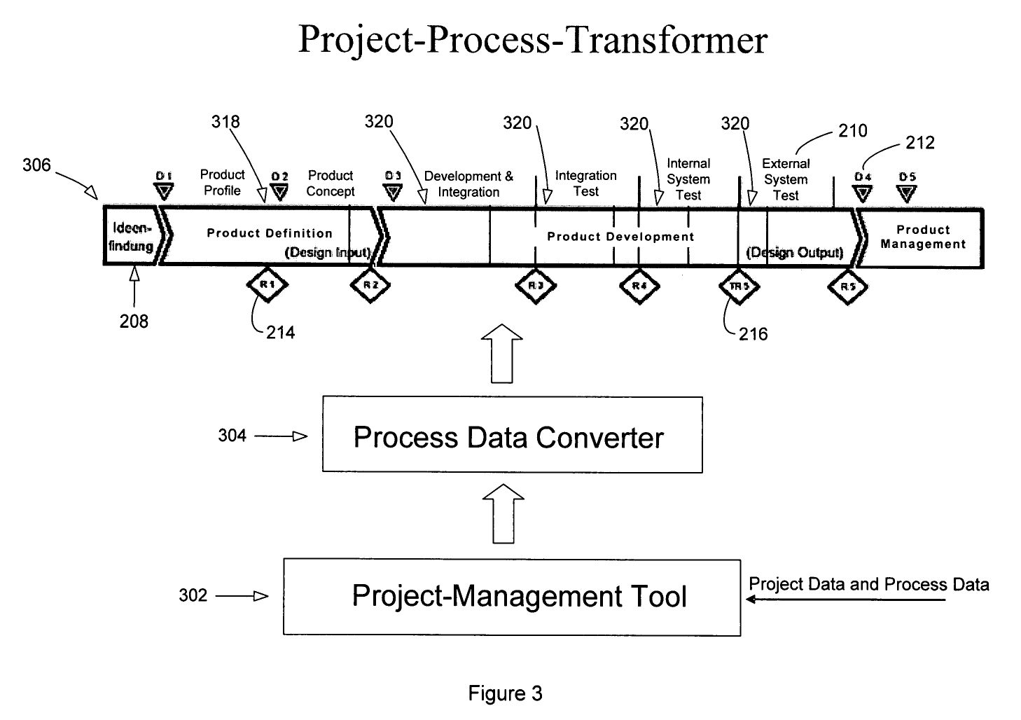

As discussed previously and shown in FIG. 3, process and project data may be collected via a project-management tool 302. A process data converter or processor 304 may correlate the data collected into the correct project portion of the process being monitored. The process template 306 may then be updated to display the current status of each project for which data was received.

Overlaying the project specific information may involve separating the process template into a plurality of project portions, each project portion representing a particular project. The status of each project may be graphically depicted within a corresponding project portion. The status of each project may correspond to the percent of the project completed or whether the project is ahead, on, or behind schedule. Other statuses may be monitored.

A project icon 320 may be generated for each project. The project icon 320 may reflect project related information based upon the process attribute data collected. The project icons 320 may be shaped as rectangles as shown in FIG. 3. In one embodiment, the degree of completion of each project may be represented by the size of the project icon 320 displayed within the corresponding project portion. The size of the project icon 320 with respect to the total size of the project portion within the process template may indicate the percent of the project estimated to be or actually completed. The project may be represented to be completed by the project being 100% filled in, such as the product profile project shown in FIG. 3. Similarly, the project may be represented to be half completed by the project portion being 50% filled in.

The status of each project may be depicted by a color scheme. For example, if the project is currently ahead of schedule, it may be represented in green, while a project currently behind schedule may be represented in red, and a project currently on schedule may be represented in yellow. Other status information may be represented and alternate project icons may be used.

A phase icon 318 may be generated for each phase. The phase icons 318 may reflect phase related information based upon the process attribute data collected. The phase icons 318 may represent similar types of information as discussed herein with respect to the project icons 320, only the phase icon representing the status of a phase, as opposed to a project. Additionally, the phase icons 318 may employ a different color scheme than, or the same color scheme, employed by the project icons.

As shown in FIG. 3, a number of the projects may be able to be performed in parallel, i.e., at the same time. For example, the product development phase may have a number of related projects simultaneously being performed. As a result, graphically depicting the current status of a number projects related to a specific phase of a process, such as the product development phase, may enable a viewer of the display to easily grasp a fuller and more accurate understanding of the overall status of the process, as compared with conventional applications.

Some projects may have to be performed primarily linearly, with one project substantially completed before the next project may be started. As shown in FIG. 3, with the product definition phase, the product profile project is completely finished while the next project, product concept, is still being performed. By visually depicting the status of each project within a phase, the status of the phase also may be visually represented. The visual depiction of which projects and phases have been completed and which projects and phases remain to be completed and/or are either behind, on, or ahead of schedule in one display may facilitate the comprehesion the current overall status of the process as a whole.

Each phase and project also may have a dedicated lower-level page. Each lower-level page may be accessible from the window displaying the graphical depiction of the process. A user may click upon a phase or project portion within the process template to assess the corresponding phase or project page, respectively. The phase or project page may include further information about the corresponding phase or project. The further information may include additional graphical or textual information, such as a spreadsheet detailing process attribute data related to the phase or project selected.

### II. Exemplary Data Processor

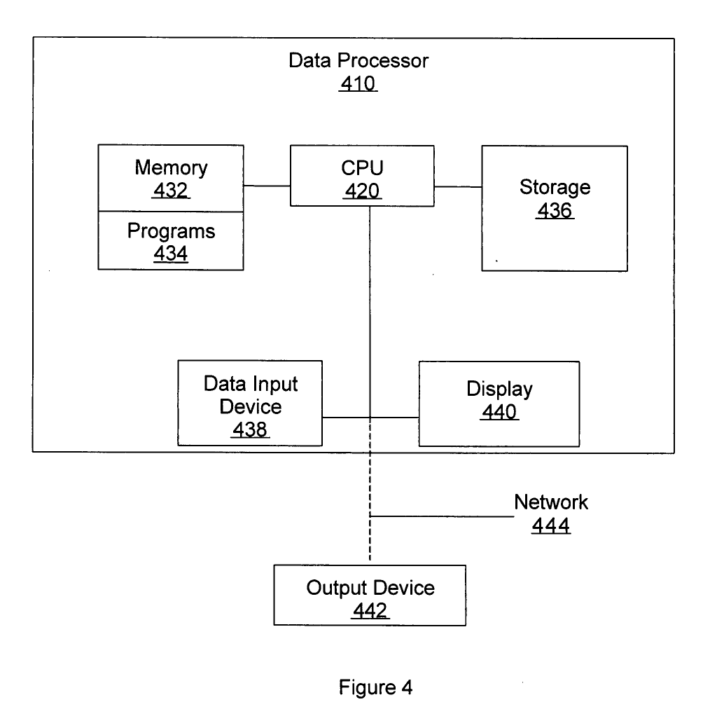

The method for visually depicting the status of a process may be facilitated by a data processing system. FIG. 4 is a block diagram of an exemplary data processor 410 configured or adapted to provide functionality for monitoring and collecting process attribute data, including process, phase, and/or project related data, and displaying the current status of the process and each phase and/or project. The data processor 410 may include a central processing unit (CPU) 420, a memory 432, a storage device 436, a data input device 438, and a display 440. The data processor 410 also may have an external output device 442, which may be a display, a monitor, a printer or a communications port. The data processor 410 may be a personal computer, work station, server, or other system. The data processor 410 may be interconnected to a network 444, such as an intranet, the Internet, or an intranet connected to the Internet. The data processor 410 may be interconnected to another location via the network 444 either by data lines or by wireless communication. The data processor 410 is provided for descriptive purposes and is not intended to limit the scope of the present system. The data processor may have additional, fewer, or alternate components.

A program 434 may reside on the memory 432, storage device 436, or another memory (e.g., hard drive removable media, RAM, or network buffer). The program 434 may include one or more sequences of executable code or coded instructions that are executed by the CPU 420. The program 434 may be loaded into the memory 432 from the storage device 436 or network or removable media. The CPU 420 may execute one or more sequences of instructions of the program 434 to process data. The program 434 may provide functionality as discussed herein.

Process, phase, and project related data may be entered via the data input device 438 or another input device, or received via the network 444 or other network. The data processor 410 may receive and store the process, phase, and project data received in the memory 432, the storage device 436, or other storage unit. The program 434 may direct that the data received be stored on or read from machine-readable medium, including secondary storage devices such as hard disks, floppy disks, CD-ROMS, and DVDs; electromagnetic signals; or other forms of machine readable medium, either currently known or later developed.

The program 434 may instruct the data processor 410 to depict the status of the process, each phase, and/or each project in one or more windows on the display 440, the external output device 442, or other display screen. The status of the process, phases, and/or projects may be depicting visually or textually. The visual depictions may include two or three dimensional graphs, such as bar charts, pie charts, tables, or other graphical depictions. The data processor 410 may retrieve the process, phase, and/or project data from machine-readable medium, including secondary storage devices such as hard disks, floppy disks, CD-ROMS, and DVDs; electromagnetic signals; or other forms of machine readable medium, either currently known or later developed.

The program 434 may direct the data processor 410 to scroll through a visual or textual depiction of the process and/or the associated phases and/or projects. The data processor 410 may divide the display 440, output device 442, or other display screen into multiple virtual sub-regions. Each of the virtual sub-regions may be associated with a specific process, corresponding phase, and/or corresponding project. For instance, the display may be split into four quadrants. One quadrant may depict the overall process and a second quadrant may depict a phase within the process, the phase including one or more projects. The remaining two quadrants may each depict a project associated with the phase being displayed. Other sub-regions may be provided.

The data processor 410 may cause the display of phase and/or project segments within a process template representing a process on the display 440, output device 442, or other display screen. The phase and/or project segments may correspond to phases and/or projects associated with the process. The data processor 410 also may cause the display of icons representing milestones on the display 440, output device 442, or other display screen. The display 440 may be a touch screen, a touch pad, a haptic device, or other vibrational or physical feedback device, but non-feedback displays may be used.

The user interface may accept one or more operations performed on the phase segments, project segments, and/or icons to present further information. For instance, the user interface may provide for the selection and display of a dedicated phase or project page after the user clicks upon a phase or process segment, respectively. The dedicated phase or project page may present further textual or graphical information related to the corresponding phase or project. The user interface also may present further textual or graphical information related to an icon representing a milestone or other check point after user selection. Other operations may be performed

The data processor 410 may generate phase and/or project overlays from the phase and/or project data, respectively. Subsequently, the data processor 410 may superimpose the phase and/or project overlays over the process template on the display 440, output device 442, or other display screen. Additionally, the data processor 410 may superimpose one or more icons over the process template on the display 440, output device 442, or other display screen. The user interface may accept one or more operations performed upon the icons and/or overlays superimposed upon the process template.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. The various embodiments are not limited to the described environments and have a wide variety of applications.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

1. A data processing system for visually depicting the status of a process, the system comprising:
a processor operable to generate a high-level graph representing a process, the high-level graph including a plurality of lower-level project portions, each of the plurality of lower-level project portions corresponding to a project associated with the process; and
a screen operable to display the high-level graph, wherein the processor is operable to monitor a current status of each project and alter the plurality of lower-level project portions displayed within the high-level graph to update the current status of the corresponding projects.

2. The system of claim 1, wherein the high-level graph includes a plurality of phase portions, each of the plurality of phase portions corresponding to a phase associated with the process, each phase including more than one project, and
the processor is operable to monitor a second current status of each phase and alter at least one of the plurality of phase portions displayed within the high-level graph to update the second current status of the corresponding phase.

3. The system of claim 2, wherein the process is a developmental process and at least one project is associated with designing or testing a medical device.

4. The system of claim 1, wherein the processor is operable to generate an icon for display on the screen representing a milestone associated with the process, and the high-level graph visually depicts the overall status of the process with respect to the milestone.

5. The system of claim 1, wherein the processor is operable to employ a color scheme to visually depict the current status of at least one project.

6. The system of claim 1, wherein the processor is operable to alter the number of the plurality of the lower-level project portions to visually depict a percent completion of the corresponding projects.

7. A method of visually depicting the status of a process, the method comprising:
displaying a high-level template representing a process on a screen, the high-level template including a plurality of project portions, each of the plurality of project portions corresponding to a project associated with the process;
collecting data associated with the process; and
automatically altering a number of the plurality of project portions displayed within the high-level template to reflect a current status of the corresponding projects based upon the data collected.

8. The method of claim 7, the method comprising displaying a dedicated project page upon the selection of one of the plurality of project portions from the high-level template, the dedicated project page displaying information associated with the project corresponding to the one of the plurality of project portions selected.

9. The method of claim 7, wherein the current status of at least one project represents a percent completion of the at least one project.

10. The method of claim 7, the method comprising visually representing a plurality of milestones on the display in relation to the high-level template to depict the overall status of the process with respect to each of the milestones.

11. The method of claim 7, the method comprising selecting a color scheme to visually depict the current status of at least one project.

12. The method of claim 7, wherein the process is a developmental process and the projects include designing, manufacturing, and testing a medical device.

13. The method of claim 7, the method comprising segregating the data collected by corresponding project and storing the segregated data in a multi-dimensional data structure that includes at least a first dimension corresponding to a particular project and a second dimension corresponding to time.

14. A method of visually depicting the status of a process, the method comprising:
selecting a plurality of projects associated with a process to monitor;
generating a process template that represents the process and the plurality of projects selected to be monitored;
collecting project data associated with the plurality of projects;
automatically determining a current status of a number of the plurality of projects from the project data; and
displaying the current status of the number of the plurality of projects within the process template such that an overall status of the process is visually depicted.

15. The method of claim 14, the method comprising:
generating a plurality of icons, each of the plurality of icons representing a milestone associated with the process; and
displaying the plurality of icons on the display in relation to the process template such that the overall status is visually depicted with respect to the milestones.

16. The method of claim 14, the method comprising selecting a color scheme to visually depict at least one current status.

17. The method of claim 14, wherein at least one current status represents a percent completion of the corresponding project.

18. The method of claim 14, the method comprising:
monitoring a plurality of processes;
segregating the project data collected by corresponding process and by time; and
storing the segregated project data in a multi-dimensional database, the multi-dimensional database having a process-related dimension, a project-related dimension, and a time-related dimension.

19. A computer-readable medium having instructions executable on a computer, the instructions comprising:
displaying a process diagram representing a process, the process diagram having a plurality of project segments, each of the plurality of project segments representing a corresponding project associated with the process;
collecting project data related to each project;
calculating a current project status of at least one project based upon the project data collected; and
visually depicting the current project status of the at least one project within the process diagram.

20. The computer-readable medium of claim 19, the instructions comprising:
classifying at least two projects as belonging to a phase associated with the process;
calculating a current phase status of the phase based upon the project data collected; and
visually depicting the current phase status within the process diagram.

21. The computer-readable medium of claim 20, the instructions comprising employing a color scheme to visually depict the current project status and the current phase status.
